(19) United States
(12) Patent Application Publication
(10) Pub. No.: US 2023/0086609 A1
(43) Pub. Date: Mar. 23, 2023

(54) SECURELY DESIGNING AND EXECUTING AN AUTOMATION WORKFLOW BASED ON VALIDATING THE AUTOMATION WORKFLOW

(71) Applicant: Accenture Global Solutions Limited, Dublin (IE)

(72) Inventors: Charles GRENET, Antony (FR); Leon WHINE, Melbourne, VIC (AU); Samuel James GLEESON, Waterloo, NSW (AU); Robert ROBINSON, East Killara, NSW (AU); Luke HIGGINS, West Pymble (AU); Aditi KULKARNI, Bangalore (IN); Koushik M VIJAYARAGHAVAN, Chennai, Tamil Nadu (IN)

(21) Appl. No.: 17/448,379

(22) Filed: Sep. 22, 2021

(51) Int. Cl. G05B 19/042; G06N 20/00

(52) U.S. Cl. CPC G05B 19/0423; G06N 20/00; G05B 2219/25433; G05B 2219/25205; G05B 2219/25011

(57) ABSTRACT

A device may receive workflow data identifying an automation request, and may request jobs for the workflow data. The device may receive encrypted jobs based on the request for the jobs, and may determine whether encryption keys for the encrypted jobs are valid. The device may determine whether workflow portions for the encrypted jobs are valid, and may determine whether to allow or deny each of the encrypted jobs based on whether the encryption keys and the workflow portions are valid. The device may execute the encrypted jobs determined to be allowed, to generate execution results, and may forgo execution of the encrypted jobs determined to be denied. The device may process the execution results and the encrypted jobs determined to be denied, with a machine learning model, to predict a final result for the automation request, and may perform actions based on the final result.

### BACKGROUND

There is a growing need for secure smart tools that can automate processes, leverage features of automation and service management tools, and provide complete insights into all aspects of automation workflow processes.

### SUMMARY

Some implementations described herein relate to a method. The method may include receiving workflow data identifying an automation request associated with automating a workflow, and requesting a plurality of jobs associated with the workflow data. The method may include receiving a plurality of encrypted jobs based on the request for the plurality of jobs, and determining whether a plurality of encryption keys associated with the plurality of encrypted jobs are valid. The method may include determining whether a plurality of workflow portions associated with the plurality of encrypted jobs are valid, and determining whether to allow or deny each of the plurality of encrypted jobs based on whether the plurality of encryption keys are valid and based on whether the plurality of workflow portions are valid. The method may include executing the plurality of encrypted jobs determined to be allowed, to generate execution results, and forgoing execution of the plurality of encrypted jobs determined to be denied. The method may include processing the execution results and the plurality of encrypted jobs determined to be denied, with a machine learning model, to predict a final result for the automation request, and performing one or more actions based on the final result.

Some implementations described herein relate to a device. The device may include one or more memories and one or more processors coupled to the one or more memories. The one or more processors may be configured to receive workflow data identifying an automation request associated with automating a workflow, and request a plurality of jobs associated with the workflow data. The one or more processors may be configured to receive a plurality of encrypted jobs based on the request for the plurality of jobs, and determine whether a plurality of encryption keys associated with the plurality of encrypted jobs are valid. The one or more processors may be configured to determine whether a plurality of workflow portions associated with the plurality of encrypted jobs are valid, and determine states associated with the plurality of workflow portions that are valid. The one or more processors may be configured to verify that the states are consistent with the workflow, and determine whether to allow or deny each of the plurality of encrypted jobs based on whether the plurality of encryption keys are valid, based on whether the plurality of workflow portions are valid, and based on verifying that the states are consistent with the workflow. The one or more processors may be configured to execute the plurality of encrypted jobs determined to be allowed, to generate execution results, and forgo execution of the plurality of encrypted jobs determined to be denied. The one or more processors may be configured to process the execution results and the plurality of encrypted jobs determined to be denied, with a machine learning model, to predict a final result for the automation request, and perform one or more actions based on the final result.

Some implementations described herein relate to a non-transitory computer-readable medium that stores a set of instructions for a device. The set of instructions, when executed by one or more processors of the device, may cause the device to receive verified workflow portions associated with a plurality of verified workflows, and store the verified workflow portions in a workflow data structure. The set of instructions, when executed by one or more processors of the device, may cause the device to receive workflow data identifying an automation request associated with automating a workflow, and request a plurality of jobs associated with the workflow data. The set of instructions, when executed by one or more processors of the device, may cause the device to receive a plurality of encrypted jobs based on the request for the plurality of jobs, and determine whether a plurality of encryption keys associated with the plurality of encrypted jobs are valid. The set of instructions, when executed by one or more processors of the device, may cause the device to determine whether a plurality of workflow portions associated with the plurality of encrypted jobs are valid based on the workflow data structure, and determine whether to allow or deny each of the plurality of encrypted jobs based on whether the plurality of encryption keys are valid and based on whether the plurality of workflow portions are valid. The set of instructions, when executed by one or more processors of the device, may cause the device to execute the plurality of encrypted jobs determined to be allowed, to generate execution results, and forgo execution of the plurality of encrypted jobs determined to be denied. The set of instructions, when executed by one or more processors of the device, may cause the device to process the execution results and the plurality of encrypted jobs determined to be denied, with a machine learning model, to predict a final result for the automation request, and perform one or more actions based on the final result.

### BRIEF DESCRIPTION OF THE DRAWINGS

FIGS. 1A-1G are diagrams of an example implementation described herein.

FIG. 2 is a diagram illustrating an example of training and using a machine learning model in connection with validating an automation workflow.

FIG. 3 is a diagram of an example environment in which systems and/or methods described herein may be implemented.

FIG. 4 is a diagram of example components of one or more devices of FIG. 3.

FIG. 5 is a flowchart of an example process for securely designing and executing an automation workflow based on validating the automation workflow.

### DETAILED DESCRIPTION

The following detailed description of example implementations refers to the accompanying drawings. The same reference numbers in different drawings may identify the same or similar elements.

An automation workflow often relies on orchestrating numerous tools and/or other actions, such as collecting user consent through emails, triggering custom scripts, integrating with third-party tools, and/or the like. Coding a workflow as scripts is typically how an automation is implemented. However, current techniques for generating an automation workflow results in difficult to maintain scripts that require automated tests (e.g., to ensure functionality), which are never implemented in practice for the scripts. Furthermore, the scripts must be analyzed in order to determine a functionality of the automation workflow, and the automation workflow is insecure since the scripts require integration with several tools, which means that the scripts need a large quantity of privileges across many sensitive tools. Therefore, current techniques for generating an automation workflow consume computing resources (e.g., processing resources, memory resources, communication resources, and/or the like), networking resources, and/or the like associated with generating insecure automation workflows, monitoring a security of the insecure automation workflows, handling security breaches associated with the insecure automation workflows, and/or the like.

Some implementations described herein relate to a workflow system that securely designs and executes an automation workflow based on validating the automation workflow. For example, the workflow system may receive workflow data identifying an automation request associated with automating a workflow, and may request a plurality of jobs associated with the workflow data. The workflow system may receive a plurality of encrypted jobs based on the request for the plurality of jobs, and may determine whether a plurality of encryption keys associated with the plurality of encrypted jobs are valid. The workflow system may determine whether a plurality of workflow portions associated with the plurality of encrypted jobs are valid, and may determine whether to allow or deny each of the plurality of encrypted jobs based on whether the plurality of encryption keys are valid and based on whether the plurality of workflow portions are valid. The workflow system may execute the plurality of encrypted jobs determined to be allowed, to generate execution results, and may forgo execution of the plurality of encrypted jobs determined to be denied. The workflow system may process the execution results and the plurality of encrypted jobs determined to be denied, with a machine learning model, to predict a final result for the automation request, and may perform one or more actions based on the final result.

In this way, the workflow system securely designs and executes an automation workflow based on validating the automation workflow. The workflow system may include an intelligent, artificial intelligence-driven cloud-native system that enables design and execution of the automation workflow in highly secure environments. The workflow system may utilize a machine learning model and/or automation rules to identify and execute relevant workflows, which may enable a more dynamic way of automation orchestration. The workflow system may verify validities of jobs associated with the automation workflow so that execution of the jobs may be securely performed. This, in turn, conserves computing resources, networking resources, and/or the like that would otherwise have been consumed in generating insecure automation workflows, monitoring a security of the insecure automation workflows, handling security breaches associated with the insecure automation workflows, and/or the like.

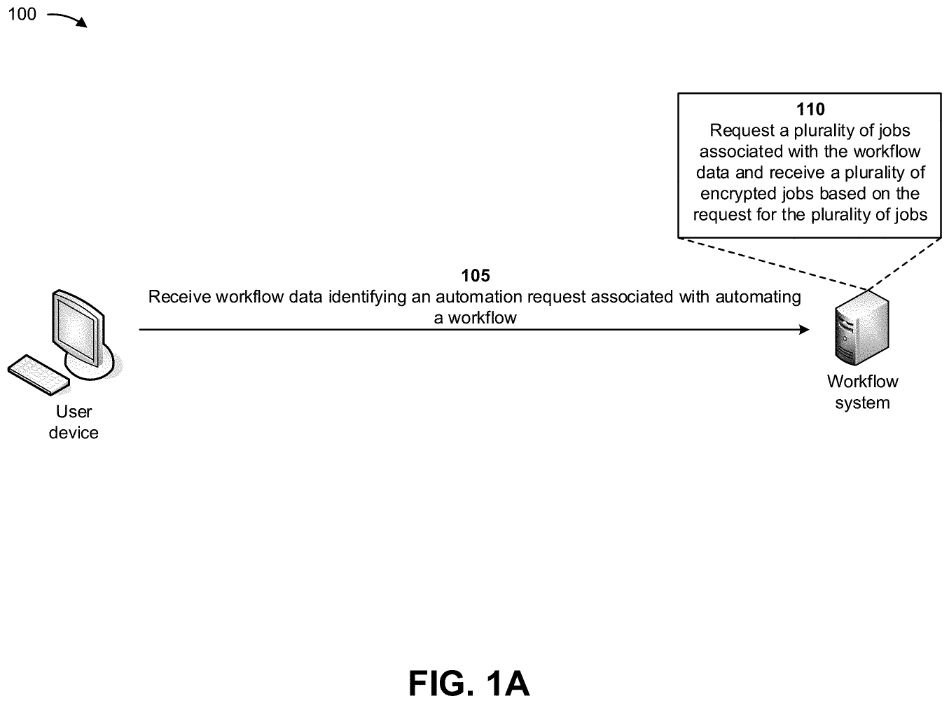

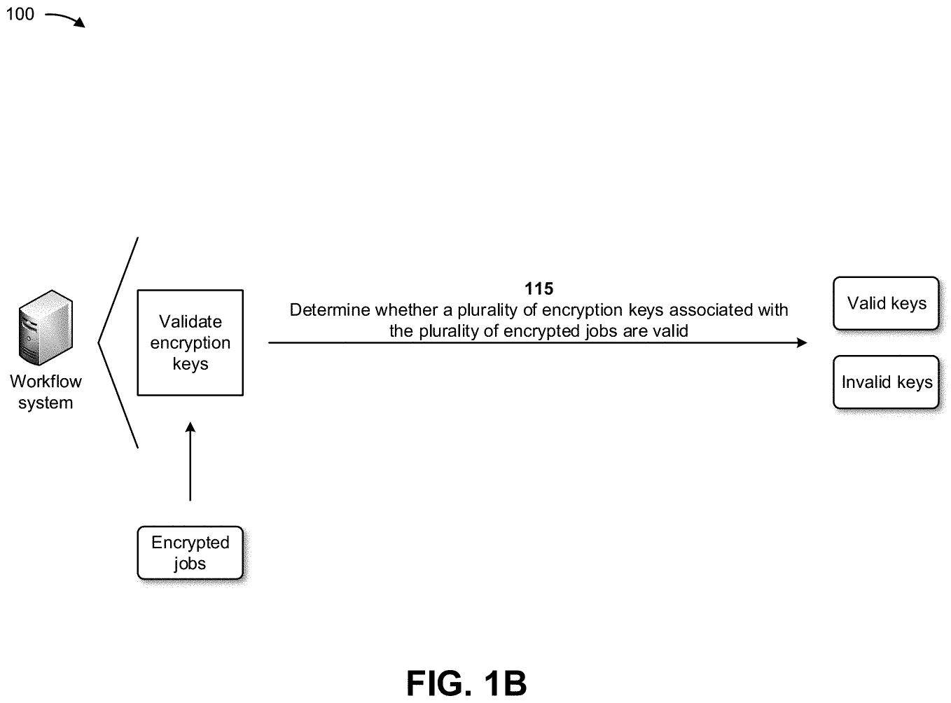

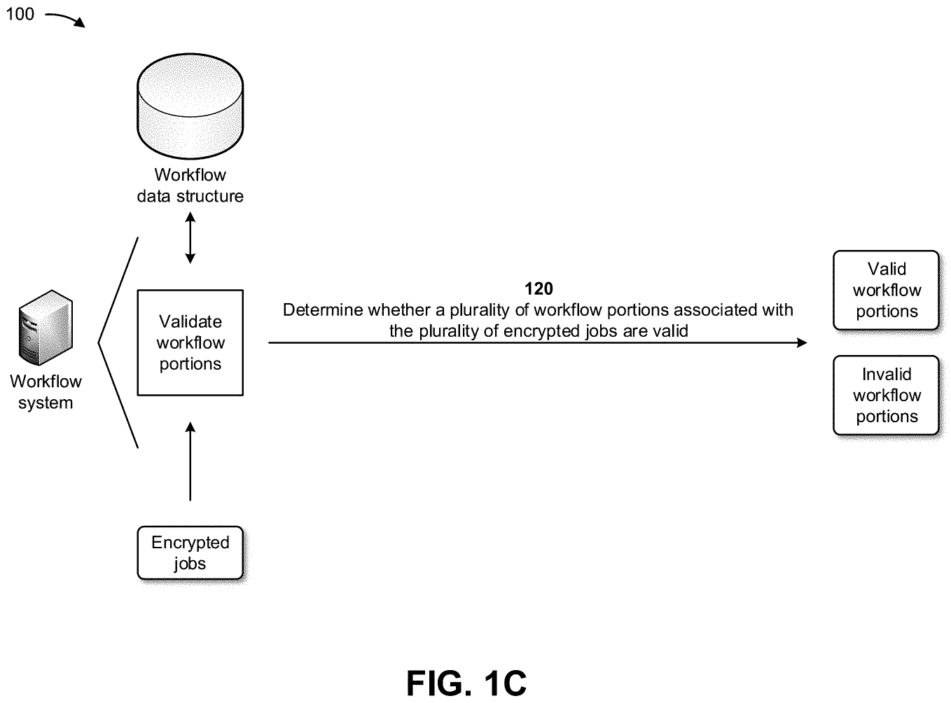

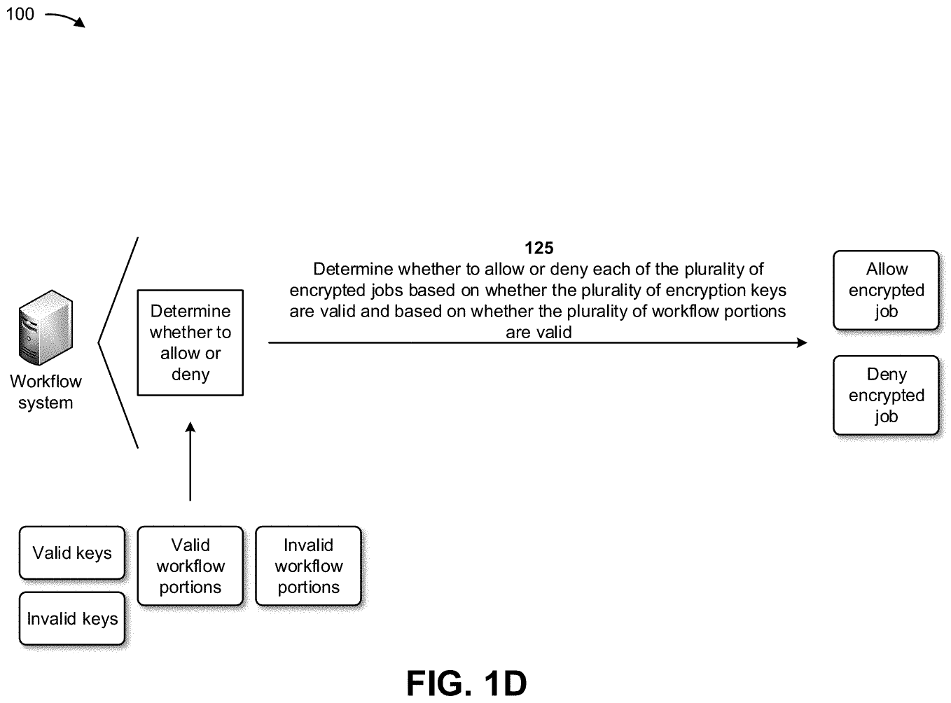

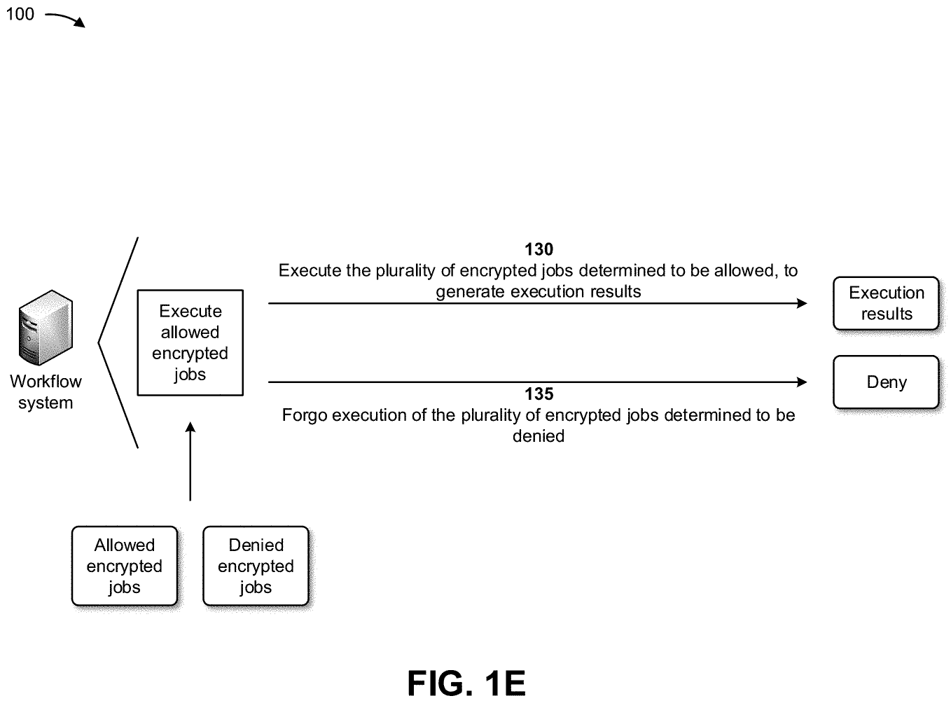

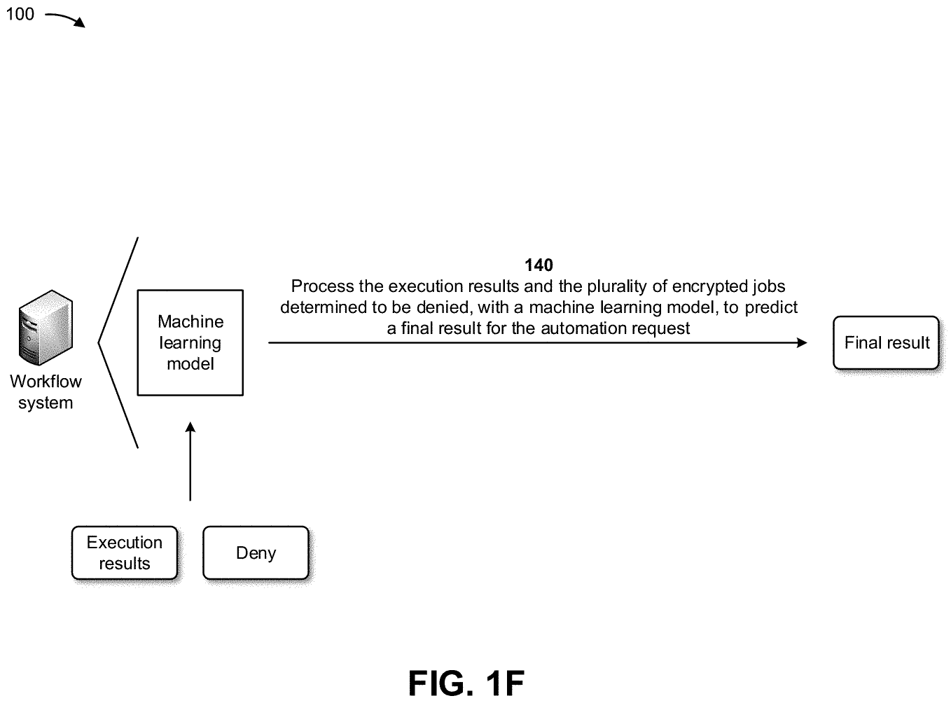

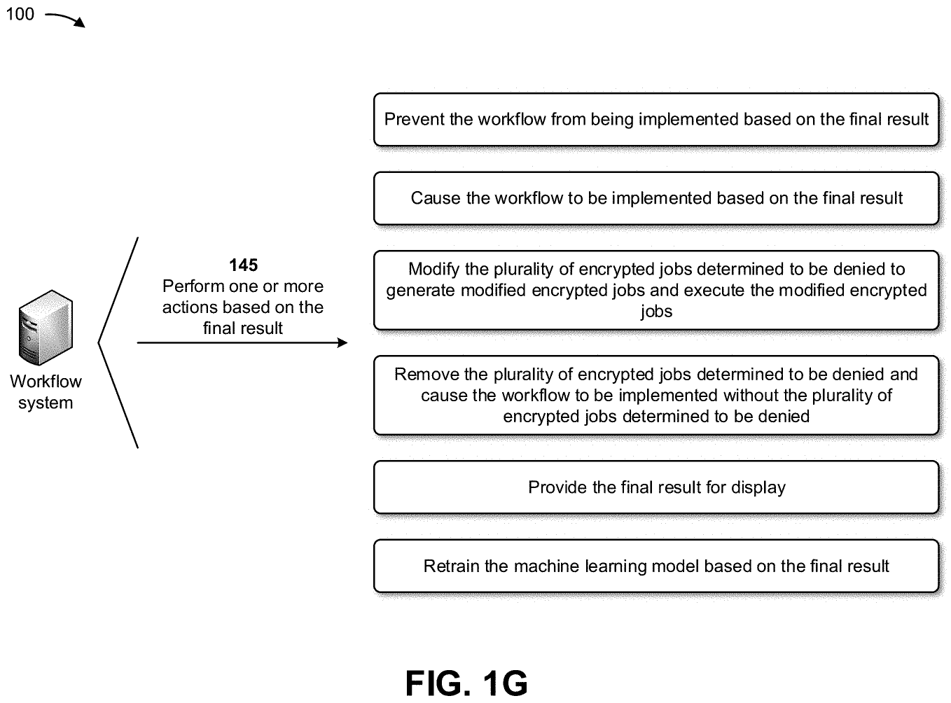

FIGS. 1A-1G are diagrams of an example 100 associated with securely designing and executing an automation workflow based on validating the automation workflow. As shown in FIGS. 1A-1G, example 100 includes a user device and a workflow system. The user device may include a wireless communication device, a mobile phone, a user equipment, a laptop computer, a tablet computer, and/or the like. The workflow system may include a system that securely designs and executes an automation workflow based on validating the automation workflow. Further details of the user device and the workflow system are provided elsewhere herein.

As shown in FIG. 1A, and by reference number 105, the workflow system may receive workflow data identifying an automation request associated with automating a workflow. For example, a user may utilize the user device to create the workflow to be automated and the automation request, and the user device may provide the workflow data identifying the automation request associated with automating the workflow to the workflow system. In some implementations, the workflow system may provide, to the user device, an application that enables the user to create the workflow. For example, the application may enable the user to utilize drag-and-drop node functionality for creating the workflow. In such an example, the user may utilize the application to add nodes to the workflow and to provide interconnections between the nodes. The nodes may represent tools to be utilized for the workflow, and the interconnections may be generated based on node entry and exit conditions. In some implementations, the workflow system may store the workflow data in a data structure (e.g., a database, a tree, a list, and/or the like) associated with the workflow system.

As further shown in FIG. 1A, and by reference number 110, the workflow system may request a plurality of jobs associated with the workflow data and may receive a plurality of encrypted jobs based on the request for the plurality of jobs. For example, the workflow may include a plurality of steps to execute and a plurality of job descriptions, where each of the plurality of job descriptions may be included in a corresponding one of the plurality of steps. The workflow may also include a plurality of job templates, where each of the plurality of job templates may be referenced in a corresponding one of the plurality of job descriptions. Each of the plurality of job templates may include data identifying a plugin to utilize, a job to call by the plugin, a list of input parameters, a list of output parameters, a mapping describing how inputs and outputs of the plugin are mapped to the list of input parameters and the list of output parameters during execution, and/or the like.

The workflow system may analyze the workflow to identify the plurality of steps to execute, the plurality of job descriptions associated with the plurality of steps, and the plurality of job templates. The workflow system may identify the plurality of jobs based on the plurality of job templates and may generate a request for the plurality of jobs based on identifying the plurality of jobs. The workflow system may provide the request for the plurality of jobs to a data structure that stores data associated with the plurality of jobs.

Base on receiving the plurality of encrypted jobs based on the request for the plurality of jobs, the workflow system may create, based on the request for the plurality of jobs, a workload object that references the workflow and includes a list of the plurality of encrypted jobs. The workflow system may identify the plurality of encrypted jobs in the data structure based on the workload object, and may receive the plurality of encrypted jobs from the data structure based on identifying the plurality of encrypted jobs. Each of the plurality of encrypted jobs may include a corresponding one of the plurality of jobs that is encrypted with an encryption key or via other encryption techniques (e.g., blockchain encryption).

As shown in FIG. 1B, and by reference number 115, the workflow system may determine whether a plurality of encryption keys associated with the plurality of encrypted jobs are valid. For example, the workflow system may be associated with an encryption key data structure that stores encryption keys determined to be valid by the workflow system. Based on determining whether the plurality of encryption keys associated with the plurality of encrypted jobs are valid, the workflow system may compare each of the plurality of encryption keys with the encryption keys stored in the encryption key data structure. The workflow system may determine that a particular encryption key, of the plurality of encryption keys, is valid when the particular encryption key matches one of the encryption keys stored in the encryption key data structure. The workflow system may determine that a particular encryption key, of the plurality of encryption keys, is invalid when the particular encryption key fails to match one of the encryption keys stored in the encryption key data structure.

As shown in FIG. 1C, and by reference number 120, the workflow system may determine whether a plurality workflow portions associated with the plurality of encrypted jobs are valid. For example, the workflow system may be associated with a workflow data structure that stores information (e.g., workflow portions) determined to be valid by the workflow system. In some implementations, the workflow system may receive verified workflow portions associated with a plurality of verified workflows, and may store the verified workflow portions in the workflow data structure. The workflow data structure may be utilized by the workflow system to determine whether the plurality of workflow portions associated with the plurality of encrypted jobs are valid.

Based on determining whether the plurality of workflow portions associated with the plurality of encrypted jobs are valid, the workflow system may compare each of the plurality of workflow portions with the information (e.g., the plurality of verified workflow portions) stored in the workflow data structure. The workflow system may determine that a particular workflow portion, of the plurality of workflow portions, is valid when the particular workflow portion matches one of the plurality of verified workflow portions stored in the workflow data structure. The workflow system may determine that a particular workflow portion, of the plurality of workflow portions, is invalid when the particular workflow portion fails to match one of the plurality of verified workflow portions stored in the workflow data structure.

In some implementations, the workflow system may determine states associated with the plurality of workflow portions that are valid, and may verify that the states, associated with the plurality of workflow portions that are valid, are consistent with the workflow. For example, the workflow system may determine that a first state associated with a first workflow portion indicates that the first workflow portion needs to complete execution prior to execution of a second workflow portion. The workflow system may also determine that a second state associated with the second workflow portion indicates that the second workflow portion is to wait for execution of the first workflow portion prior to executing. In such an example, the workflow system may determine that the states associated with the plurality of workflow portions are consistent with the workflow. If the workflow system determines that a state associated with one of the plurality of workflow portions is invalid or inconsistent with a state associated with another one of the plurality of workflow portions, the workflow system may determine that the one of the plurality of workflow portions is invalid.

As shown in FIG. 1D, and by reference number 125, the workflow system may determine whether to allow or deny each of the plurality of encrypted jobs based on whether the plurality of encryption keys are valid and based on whether the plurality of workflow portions are valid. For example, the workflow system may determine to allow a particular encrypted job, of the plurality of encrypted jobs, when a corresponding encryption key and a corresponding workflow portion are determined to be valid. The workflow system may determine to deny a particular encrypted job, of the plurality of encrypted jobs, when a corresponding encryption key is determined to be invalid, and a corresponding workflow portion is determined to be valid. The workflow system may also determine to deny a particular encrypted job, of the plurality of encrypted jobs, when a corresponding encryption key is determined to be valid, and a corresponding workflow portion is determined to be invalid. The workflow system may make this determination for each of the plurality of encrypted jobs in order to identify the plurality of encrypted jobs determined to be allowed and the plurality of encrypted jobs determined to be denied.

As shown in FIG. 1E, and by reference number 130, the workflow system may execute the plurality of encrypted jobs determined to be allowed, to generate execution results. In some implementations, based on executing the plurality of encrypted jobs determined to be allowed, to generate execution results, the workflow system may identify plugins (e.g., as referenced in job templates associated with the plurality of encrypted jobs determined to be allowed) to execute the plurality of encrypted jobs determined to be allowed. The workflow system may populate input parameters of the job templates, associated with the plurality of encrypted jobs determined to be allowed, based on job template mappings. The job template mappings describe how inputs and outputs of the plugins are mapped to a list of input parameters and a list of output parameters during execution of the plurality of encrypted jobs determined to be allowed. The workflow system may compute plugin parameters for the plugins based on populating the input parameters of the job templates, and may execute the plurality of encrypted jobs determined to be allowed based on the plugin parameters. For example, if a plugin includes two input parameters A and B and is to compute a sum of the two input parameters, the workflow system may create a job template that utilizes the plugin to add a constant to a number. The workflow system may define the job template with one input parameter X, and may specify the mappings, A={X} and B=10. If the workflow includes an input parameter named INPUT, the workflow system may inject this input parameter into the job template with a mapping rule, X={INPUT}. The workflow system may compute plugin parameters based on computing A and B from INPUT.

As further shown in FIG. 1E, and by reference number 135, the workflow system may forgo execution of the plurality of encrypted jobs determined to be denied. For example, the workflow system may not execute the plurality of encrypted jobs determined to be denied since encryption keys and/or workflow portions, associated with the plurality of encrypted jobs determined to be denied, are invalid and not trustworthy. In this way, the workflow system may prevent execution of insecure encrypted jobs and/or security breaches associated with execution of such insecure encrypted jobs.

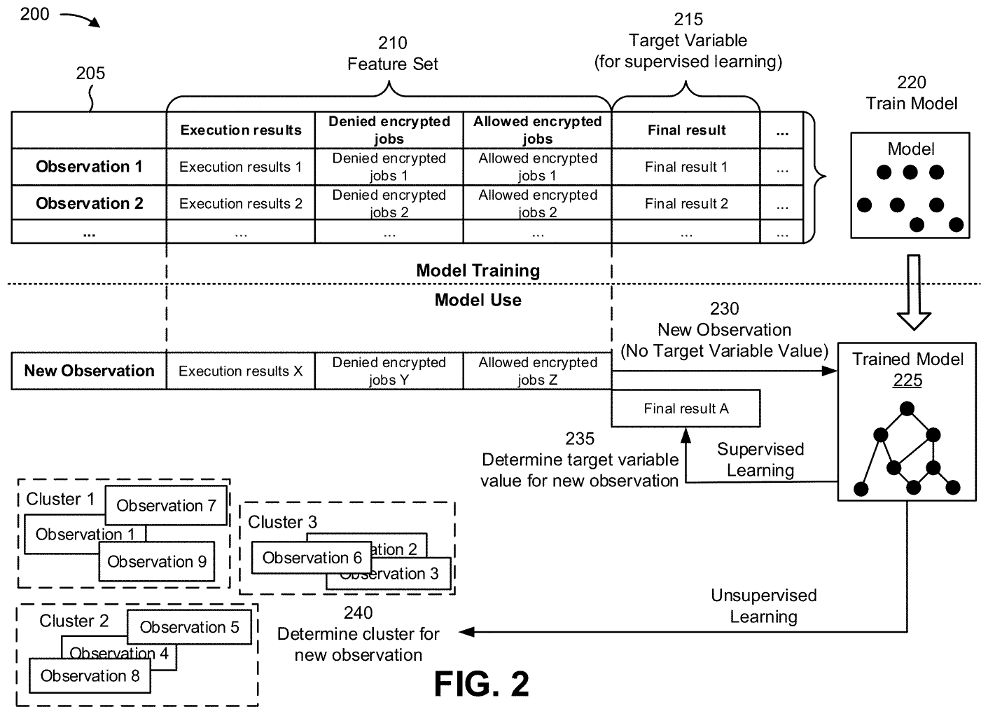

As shown in FIG. 1F, and by reference number 140, the workflow system may process the execution results and the plurality of encrypted jobs determined to be denied, with a machine learning model, to predict a final result for the automation request. For example, the machine learning model may identify a first quantity of the execution results that are valid and a second quantity (if any) of the execution results that generate errors. The machine learning model may identify a third quantity (if any) of the plurality of encrypted jobs determined to be denied, and may subtract the second quantity and the third quantity from the first quantity to determine a final quantity. The machine learning model may compare the final quantity with a threshold quantity associated with the final result. If the final quantity satisfies the threshold quantity, the machine learning model may determine the final result to be approval of the automation request, approval of the automation request without the plurality of encrypted jobs associated with execution errors or determined to be denied, and/or the like. If the final quantity fails to satisfy the threshold quantity, the machine learning model may determine the final result to be denial of the automation request, denial of the automation request for the plurality of encrypted jobs associated with valid execution results, and/or the like. Further details of the machine learning model are provided below in connection with FIG. 2.

As shown in FIG. 1G, and by reference number 145, the workflow system may perform one or more actions based on the final result. In some implementations, performing the one or more actions includes the workflow system preventing the workflow from being implemented based on the final result. For example, the workflow system, via the machine learning model, may determine the final result to be denial of the automation request. Based on this final result, the workflow system may prevent the workflow from being implemented by the user associated with the user device. For example, the workflow system may prevent the user from accessing tools associated with the workflow to prevent the workflow from being implemented. In this way, the workflow system conserves computing resources, networking resources, and/or the like that would otherwise have been consumed in generating insecure automation workflows, monitoring a security of the insecure automation workflows, handling security breaches associated with the insecure automation workflows, and/or the like.

In some implementations, performing the one or more actions includes the workflow system causing the workflow to be implemented based on the final result. For example, the workflow system, via the machine learning model, may determine the final result to be approval of the automation request. Based on this final result, the workflow system may cause the workflow to be implemented by the user associated with the user device. For example, the workflow system may permit the user to access tools associated with the workflow so that the workflow may be implemented. In this way, the workflow system conserves computing resources, networking resources, and/or the like that would otherwise have been consumed in generating insecure automation workflows, handling security breaches associated with the insecure automation workflows, and/or the like.

In some implementations, performing the one or more actions includes the workflow system modifying the plurality of encrypted jobs determined to be denied to generate modified encrypted jobs and executing the modified encrypted jobs. For example, the workflow system may modify the plurality encrypted jobs determined to be denied so that such encrypted jobs may be approved by the workflow system. In one example, the workflow system may modify workflow portions of the plurality of encrypted jobs determined to be denied in order to generate the modified encrypted jobs. The workflow system may execute the modified encrypted jobs to generate additional execution results and may include the additional execution results with the execution results. In this way, the workflow system conserves computing resources, networking resources, and/or the like that would otherwise have been consumed in generating insecure automation workflows, monitoring a security of the insecure automation workflows, and/or the like.

In some implementations, performing the one or more actions includes the workflow system removing the plurality of encrypted jobs determined to be denied and causing the workflow to be implemented without the plurality of encrypted jobs determined to be denied. For example, the workflow system, via the machine learning model, may determine the final result to be approval of the automation request without the plurality of encrypted jobs determined to be denied. Based on this final result, the workflow system may remove the plurality of encrypted jobs determined to be denied from the workflow, and may cause the workflow to be implemented by the user associated with the user device. For example, the workflow system may permit the user to access tools associated with the workflow so that the workflow may be implemented. In this way, the workflow system conserves computing resources, networking resources, and/or the like that would otherwise have been consumed in generating insecure automation workflows, and/or the like.

In some implementations, performing the one or more actions includes the workflow system providing the final result for display. For example, the workflow system may provide, to the user device, an indication of the final result (e.g., approval of the automation request or denial of the automation request). If the final result is approval of the automation request, the user may utilize the user device to access tools associated with the workflow so that the workflow may be implemented. In this way, the workflow system conserves computing resources, networking resources, and/or the like that would otherwise have been consumed in generating insecure automation workflows, monitoring a security of the insecure automation workflows, handling security breaches associated with the insecure automation workflows, and/or the like.

In some implementations, performing the one or more actions includes the workflow system retraining the machine learning model based on the final result. For example, the workflow system may utilize the final result as additional training data for retraining the machine learning model, thereby increasing the quantity of training data available for training the machine learning model. Accordingly, the workflow system may conserve computing resources associated with identifying, obtaining, and/or generating historical data for training the machine learning model relative to other systems for identifying, obtaining, and/or generating historical data for training machine learning models.

In this way, the workflow system securely designs and executes an automation workflow based on validating the automation workflow. The workflow system may include an intelligent, artificial intelligence-driven cloud-native system that enables design and execution of the automation workflow in highly secure environments. The workflow system may utilize a machine learning model and/or automation rules to identify and execute relevant workflows, which may enable a more dynamic way of automation orchestration. The workflow system may verify validities of jobs associated with the automation workflow so that execution of the jobs may be securely performed. This, in turn, conserves computing resources, networking resources, and/or the like that would otherwise have been consumed in generating insecure automation workflows, monitoring a security of the insecure automation workflows, handling security breaches associated with the insecure automation workflows, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram illustrating an example 200 of training and using a machine learning model in connection with validating an automation workflow. The machine learning model training and usage described herein may be performed using a machine learning system. The machine learning system may include or may be included in a computing device, a server, a cloud computing environment, and/or the like, such as the workflow system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the workflow system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the workflow system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of execution results, a second feature of denied encrypted jobs, a third feature of allowed encrypted jobs, and so on. As shown, for a first observation, the first feature may have a value of execution results 1, the second feature may have a value of denied encrypted jobs 1, the third feature may have a value of allowed encrypted jobs 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is a final result, which has a value of final result 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of execution results X, a second feature of denied encrypted jobs Y, a third feature of allowed encrypted jobs Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of final result A for the target variable of the final result for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., an execution results cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a denied encrypted jobs cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to validate an automation workflow. The machine learning system enables recognition and/or identification of tens, hundreds, thousands, or millions of features and/or feature values for tens, hundreds, thousands, or millions of observations, thereby increasing accuracy and consistency and reducing delay associated with validating an automation workflow relative to requiring computing resources to be allocated for tens, hundreds, or thousands of operators to manually validate the automation workflow.

As indicated above, FIG. 2 is provided as an example. Other examples may differ from what is described in connection with FIG. 2.

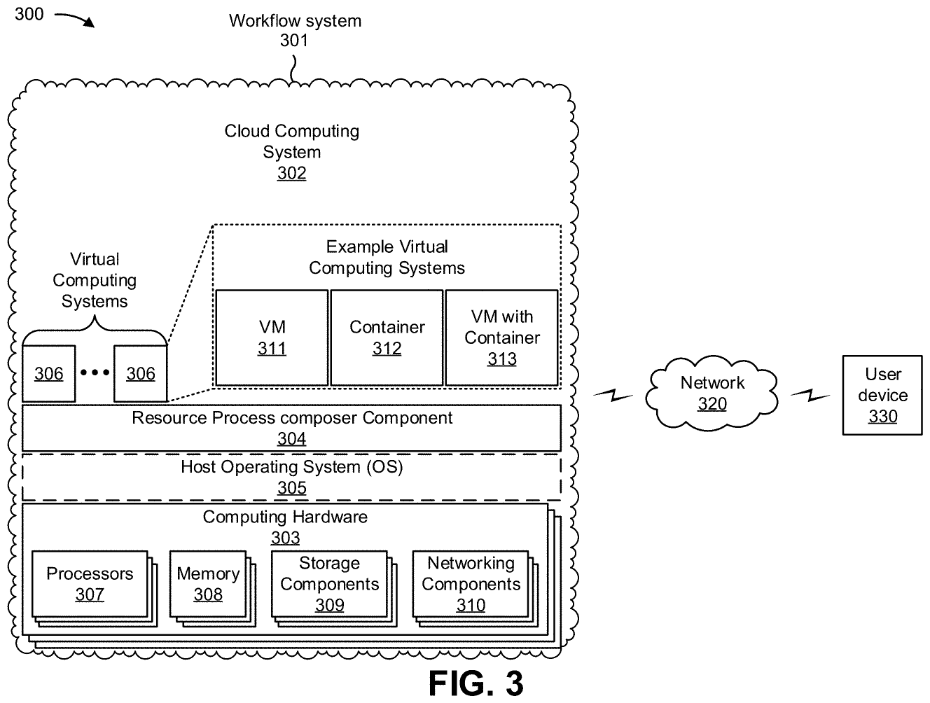

FIG. 3 is a diagram of an example environment 300 in which systems and/or methods described herein may be implemented. As shown in FIG. 3, the environment 300 may include a workflow system 301, which may include one or more elements of and/or may execute within a cloud computing system 302. The cloud computing system 302 may include one or more elements 303-313, as described in more detail below. As further shown in FIG. 3, the environment 300 may include a network 320 and/or a user device 330. Devices and/or elements of the environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of the computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing the computing hardware 303 to start, stop, and/or manage the one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

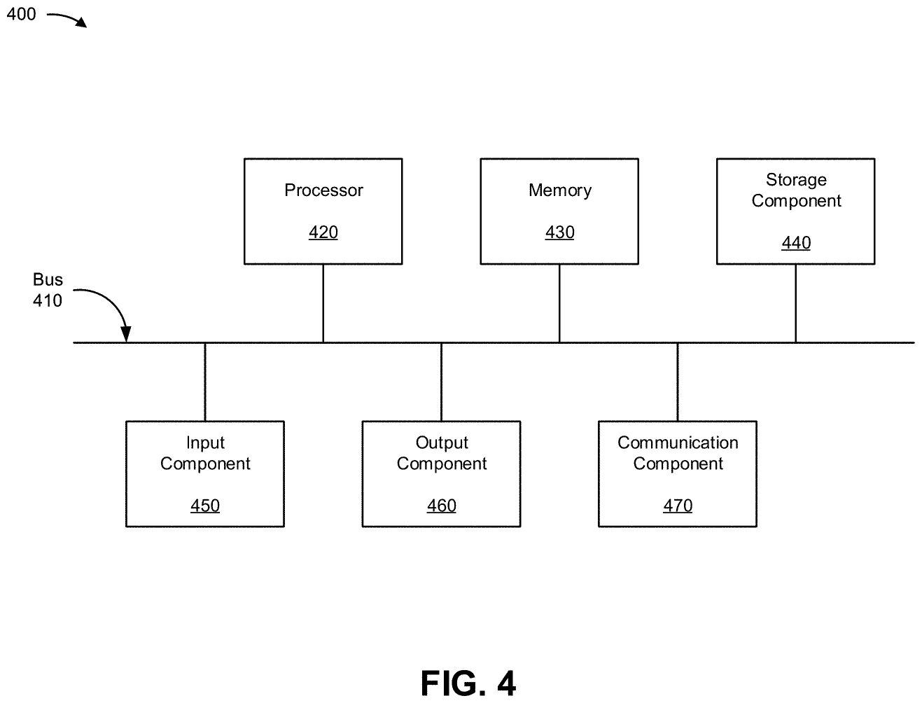

Although the workflow system 301 may include one or more elements 303-313 of the cloud computing system 302, may execute within the cloud computing system 302, and/or may be hosted within the cloud computing system 302, in some implementations, the workflow system 301 may not be cloud-based (e.g., may be implemented outside of a cloud computing system) or may be partially cloud-based. For example, the workflow system 301 may include one or more devices that are not part of the cloud computing system 302, such as device 400 of FIG. 4, which may include a standalone server or another type of computing device. The workflow system 301 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or the like, and/or a combination of these or other types of networks. The network 320 enables communication among the devices of the environment 300.

The user device 330 includes one or more devices capable of receiving, generating, storing, processing, and/or providing information, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the workflow system 301 and/or the user device 330. In some implementations, the workflow system 301 and/or the user device 330 may include one or more devices 400 and/or one or more components of the device 400. As shown in FIG. 4, the device 400 may include a bus 410, a processor 420, a memory 430, a storage component 440, an input component 450, an output component 460, and a communication component 470.

The bus 410 includes a component that enables wired and/or wireless communication among the components of device 400. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform a function. The memory 430 includes a random-access memory, a read only memory, and/or another type of memory (e.g., a flash memory, a magnetic memory, and/or an optical memory).

The storage component 440 stores information and/or software related to the operation of the device 400. For example, the storage component 440 may include a hard disk drive, a magnetic disk drive, an optical disk drive, a solid-state disk drive, a compact disc, a digital versatile disc, and/or another type of non-transitory computer-readable medium. The input component 450 enables the device 400 to receive input, such as user input and/or sensed inputs. For example, the input component 450 may include a touch screen, a keyboard, a keypad, a mouse, a button, a microphone, a switch, a sensor, a global positioning system component, an accelerometer, a gyroscope, an actuator, and/or the like. The output component 460 enables the device 400 to provide output, such as via a display, a speaker, and/or one or more light-emitting diodes. The communication component 470 enables the device 400 to communicate with other devices, such as via a wired connection and/or a wireless connection. For example, the communication component 470 may include a receiver, a transmitter, a transceiver, a modem, a network interface card, an antenna, and/or the like.

The device 400 may perform one or more processes described herein. For example, a non-transitory computer-readable medium (e.g., the memory 430 and/or the storage component 440) may store a set of instructions (e.g., one or more instructions, code, software code, program code, and/or the like) for execution by the processor 420. The processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

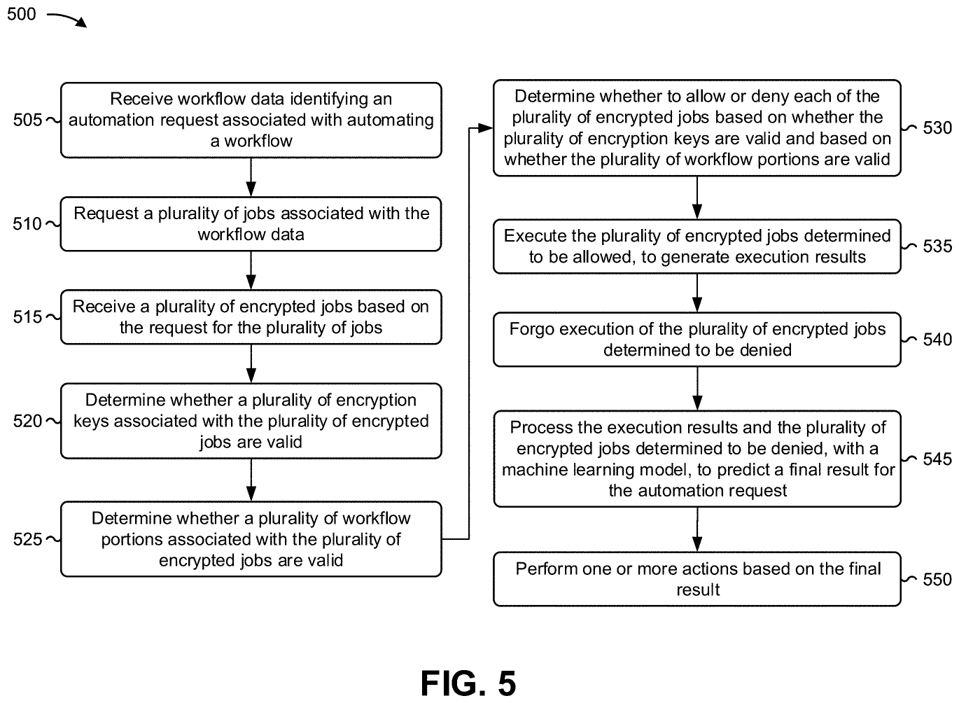

FIG. 5 is a flowchart of an example process 500 for securely designing and executing an automation workflow based on validating the automation workflow. In some implementations, one or more process blocks of FIG. 5 may be performed by a device (e.g., the workflow system 301). In some implementations, one or more process blocks of FIG. 5 may be performed by another device or a group of devices separate from or including the device, such as a user device (e.g., the user device 330). Additionally, or alternatively, one or more process blocks of FIG. 5 may be performed by one or more components of the device 400, such as the processor 420, the memory 430, the storage component 440, the input component 450, the output component 460, and/or the communication component 470.

As shown in FIG. 5, process 500 may include receiving workflow data identifying an automation request associated with automating a workflow (block 505). For example, the device may receive workflow data identifying an automation request associated with automating a workflow, as described above. In some implementations, the workflow data includes data identifying a workflow diagram with one or more nodes and interconnections between the one or more nodes. In some implementations, the workflow includes a plurality of steps to execute; a plurality of job descriptions, where each of the plurality of job descriptions is included in a corresponding one of the plurality of steps; and a plurality of job templates, wherein each of the plurality of job templates is referenced in a corresponding one of the plurality of job descriptions. In some implementations, each of the plurality of job templates includes data identifying one or more of a plugin to utilize, a job to call by the plugin, a list of input parameters, a list of output parameters, or a mapping describing how inputs and outputs of the plugin are mapped to the list of input parameters and the list of output parameters during execution.

As further shown in FIG. 5, process 500 may include requesting a plurality of jobs associated with the workflow data (block 510). For example, the device may request a plurality of jobs associated with the workflow data, as described above.

As further shown in FIG. 5, process 500 may include receiving a plurality of encrypted jobs based on the request for the plurality of jobs (block 515). For example, the device may receive a plurality of encrypted jobs based on the request for the plurality of jobs, as described above. In some implementations, receiving the plurality of encrypted jobs based on the request for the plurality of jobs includes creating, based on the request for the plurality of jobs, a workload object that references the workflow and includes a list of the plurality of encrypted jobs; identifying the plurality of encrypted jobs in a data structure based on the workload object; and receiving the plurality of encrypted jobs from the data structure.

As further shown in FIG. 5, process 500 may include determining whether a plurality of encryption keys associated with the plurality of encrypted jobs are valid (block 520). For example, the device may determine whether a plurality of encryption keys associated with the plurality of encrypted jobs are valid, as described above.

As further shown in FIG. 5, process 500 may include determining whether a plurality of workflow portions associated with the plurality of encrypted jobs are valid (block 525). For example, the device may determine whether a plurality of workflow portions associated with the plurality of encrypted jobs are valid, as described above. In some implementations, determining whether the plurality of workflow portions associated with the plurality of encrypted jobs are valid includes comparing each of the plurality of workflow portions with information stored in a workflow data structure; determining that one or more first workflow portions, included in the information, are valid; and determining that one or more second workflow portions, not included in the information, are invalid.

As further shown in FIG. 5, process 500 may include determining whether to allow or deny each of the plurality of encrypted jobs based on whether the plurality of encryption keys are valid and based on whether the plurality of workflow portions are valid (block 530). For example, the device may determine whether to allow or deny each of the plurality of encrypted jobs based on whether the plurality of encryption keys are valid and based on whether the plurality of workflow portions are valid, as described above.

As further shown in FIG. 5, process 500 may include executing the plurality of encrypted jobs determined to be allowed, to generate execution results (block 535). For example, the device may execute the plurality of encrypted jobs determined to be allowed, to generate execution results, as described above. In some implementations, executing the plurality of encrypted jobs determined to be allowed, to generate execution results, includes identifying plugins to execute the plurality of encrypted jobs determined to be allowed, populating input parameters of job templates associated with the plurality of encrypted jobs determined to be allowed based on job template mappings, computing plugin parameters for the plugins based on populating the input parameters of the job templates, and executing the plurality of encrypted jobs determined to be allowed based on the plugin parameters.

As further shown in FIG. 5, process 500 may include forgoing execution of the plurality of encrypted jobs determined to be denied (block 540). For example, the device may forgo execution of the plurality of encrypted jobs determined to be denied, as described above.

As further shown in FIG. 5, process 500 may include processing the execution results and the plurality of encrypted jobs determined to be denied, with a machine learning model, to predict a final result for the automation request (block 545). For example, the device may process the execution results and the plurality of encrypted jobs determined to be denied, with a machine learning model, to predict a final result for the automation request, as described above.

As further shown in FIG. 5, process 500 may include performing one or more actions based on the final result (block 550). For example, the device may perform one or more actions based on the final result, as described above. In some implementations, performing the one or more actions includes one or more of preventing the workflow from being implemented based on the final result, or causing the workflow to be implemented based on the final result. In some implementations, performing the one or more actions includes one or more of providing the final result for display, or retraining the machine learning model based on the final result.

In some implementations, performing the one or more actions includes modifying the plurality of encrypted jobs determined to be denied to generate modified encrypted jobs; executing the modified encrypted jobs to generate additional execution results; processing the execution results and the additional execution results, with the machine learning model, to predict a modified final result for the automation request; and performing one or more additional actions based on the modified final result.

In some implementations, performing the one or more actions includes removing the plurality of encrypted jobs determined to be denied from the workflow, and causing the workflow to be implemented without the plurality of encrypted jobs determined to be denied.

In some implementations, process 500 includes determining states associated with the plurality of workflow portions that are valid, and verifying that the states are consistent with the workflow.

In some implementations, process 500 includes receiving verified workflow portions associated with a plurality of verified workflows, and storing the verified workflow portions in a workflow data structure, wherein the workflow data structure is utilized to determine whether the plurality of workflow portions associated with the plurality of encrypted jobs are valid.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, workflow data identifying an automation request associated with automating a workflow;
requesting, by the device, a plurality of jobs associated with the workflow data;
receiving, by the device, a plurality of encrypted jobs based on the request for the plurality of jobs;
determining, by the device, whether a plurality of encryption keys associated with the plurality of encrypted jobs are valid;
determining, by the device, whether a plurality of workflow portions associated with the plurality of encrypted jobs are valid;
determining, by the device, whether to allow or deny each of the plurality of encrypted jobs based on whether the plurality of encryption keys are valid and based on whether the plurality of workflow portions are valid;
executing, by the device, the plurality of encrypted jobs determined to be allowed, to generate execution results;
forgoing, by the device, execution of the plurality of encrypted jobs determined to be denied;
processing, by the device, the execution results and the plurality of encrypted jobs determined to be denied, with a machine learning model, to predict a final result for the automation request; and
performing, by the device, one or more actions based on the final result.

2. The method of claim 1, wherein the workflow data includes data identifying a workflow diagram with one or more nodes and interconnections between the one or more nodes.

3. The method of claim 1, wherein determining whether the plurality of workflow portions associated with the plurality of encrypted jobs are valid comprises:
comparing each of the plurality of workflow portions with information stored in a workflow data structure;
determining that one or more first workflow portions, included in the information, are valid; and
determining that one or more second workflow portions, not included in the information, are invalid.

4. The method of claim 1, further comprising:
determining states associated with the plurality of workflow portions that are valid; and
verifying that the states are consistent with the workflow.

5. The method of claim 1, wherein receiving the plurality of encrypted jobs based on the request for the plurality of jobs comprises:
creating, based on the request for the plurality of jobs, a workload object that references the workflow and includes a list of the plurality of encrypted jobs;
identifying the plurality of encrypted jobs in a data structure based on the workload object; and
receiving the plurality of encrypted jobs from the data structure.

6. The method of claim 1, wherein the workflow includes:
a plurality of steps to execute,
a plurality of job descriptions,
wherein each of the plurality of job descriptions is included in a corresponding one of the plurality of steps, and
a plurality of job templates,
wherein each of the plurality of job templates is referenced in a corresponding one of the plurality of job descriptions.

7. The method of claim 6, wherein each of the plurality of job templates includes data identifying one or more of:
a plugin to utilize,
a job to call by the plugin,
a list of input parameters,
a list of output parameters, or
a mapping describing how inputs and outputs of the plugin are mapped to the list of input parameters and the list of output parameters during execution.

8. A device, comprising:
one or more memories; and
one or more processors, coupled to the one or more memories, configured to:
receive workflow data identifying an automation request associated with automating a workflow;
request a plurality of jobs associated with the workflow data;
receive a plurality of encrypted jobs based on the request for the plurality of jobs;
determine whether a plurality of encryption keys associated with the plurality of encrypted jobs are valid;
determine whether a plurality of workflow portions associated with the plurality of encrypted jobs are valid;
determine states associated with the plurality of workflow portions that are valid;
verify that the states are consistent with the workflow;
determine whether to allow or deny each of the plurality of encrypted jobs based on whether the plurality of encryption keys are valid, based on whether the plurality of workflow portions are valid, and based on verifying that the states are consistent with the workflow;
execute the plurality of encrypted jobs determined to be allowed, to generate execution results;
forgo execution of the plurality of encrypted jobs determined to be denied;
process the execution results and the plurality of encrypted jobs determined to be denied, with a machine learning model, to predict a final result for the automation request; and
perform one or more actions based on the final result.

9. The device of claim 8, wherein the one or more processors, to execute the plurality of encrypted jobs determined to be allowed, to generate execution results, are configured to:
identify plugins to execute the plurality of encrypted jobs determined to be allowed;
populate input parameters of job templates associated with the plurality of encrypted jobs determined to be allowed based on job template mappings;
compute plugin parameters for the plugins based on populating the input parameters of the job templates; and
execute the plurality of encrypted jobs determined to be allowed based on the plugin parameters.

10. The device of claim 8, wherein the one or more processors are further configured to:
receive verified workflow portions associated with a plurality of verified workflows; and
store the verified workflow portions in a workflow data structure,
wherein the workflow data structure is utilized to determine whether the plurality of workflow portions associated with the plurality of encrypted jobs are valid.

11. The device of claim 8, wherein the one or more processors, to perform the one or more actions, are configured to one or more of:
prevent the workflow from being implemented based on the final result; or
cause the workflow to be implemented based on the final result.

12. The device of claim 8, wherein the one or more processors, to perform the one or more actions, are configured to one or more of:
provide the final result for display; or
retrain the machine learning model based on the final result.

13. The device of claim 8, wherein the one or more processors, to perform the one or more actions, are configured to:
modify the plurality of encrypted jobs determined to be denied to generate modified encrypted jobs;
execute the modified encrypted jobs to generate additional execution results;
process the execution results and the additional execution results, with the machine learning model, to predict a modified final result for the automation request; and
perform one or more additional actions based on the modified final result.

14. The device of claim 8, wherein the one or more processors, to perform the one or more actions, are configured to:
remove the plurality of encrypted jobs determined to be denied from the workflow; and
cause the workflow to be implemented without the plurality of encrypted jobs determined to be denied.

15. A non-transitory computer-readable medium storing a set of instructions, the set of instructions comprising:
one or more instructions that, when executed by one or more processors of a device, cause the device to:
receive verified workflow portions associated with a plurality of verified workflows;
store the verified workflow portions in a workflow data structure;
receive workflow data identifying an automation request associated with automating a workflow;
request a plurality of jobs associated with the workflow data;
receive a plurality of encrypted jobs based on the request for the plurality of jobs;
determine whether a plurality of encryption keys associated with the plurality of encrypted jobs are valid;
determine whether a plurality of workflow portions associated with the plurality of encrypted jobs are valid based on the workflow data structure;
determine whether to allow or deny each of the plurality of encrypted jobs based on whether the plurality of encryption keys are valid and based on whether the plurality of workflow portions are valid;
execute the plurality of encrypted jobs determined to be allowed, to generate execution results;
forgo execution of the plurality of encrypted jobs determined to be denied;
process the execution results and the plurality of encrypted jobs determined to be denied, with a machine learning model, to predict a final result for the automation request; and
perform one or more actions based on the final result.

16. The non-transitory computer-readable medium of claim 15, wherein the one or more instructions, that cause the device to determine whether the plurality of workflow portions associated with the plurality of encrypted jobs are valid based on the workflow data structure, cause the device to:
compare each of the plurality of workflow portions with the verified workflow portions stored in the workflow data structure;
determine that one or more first workflow portions, included in the verified workflow portions, are valid; and
determine that one or more second workflow portions, not included in the verified workflow portions, are invalid.

17. The non-transitory computer-readable medium of claim 15, wherein the one or more instructions further cause the device to:
determine states associated with the plurality of workflow portions that are valid; and
verify that the states are consistent with the workflow.

18. The non-transitory computer-readable medium of claim 15, wherein the one or more instructions, that cause the device to receive the plurality of encrypted jobs based on the request for the plurality of jobs, cause the device to:
create, based on the request for the plurality of jobs, a workload object that references the workflow and includes a list of the plurality of encrypted jobs;
identify the plurality of encrypted jobs in a data structure based on the workload object; and
receive the plurality of encrypted jobs from the data structure.

19. The non-transitory computer-readable medium of claim 15, wherein the one or more instructions, that cause the device to execute the plurality of encrypted jobs determine to be allowed, to generate execution results, cause the device to:
identify plugins to execute the plurality of encrypted jobs determined to be allowed;
populate input parameters of job templates associated with the plurality of encrypted jobs determined to be allowed based on job template mappings;
compute plugin parameters for the plugins based on populating the input parameters of the job templates; and
execute the plurality of encrypted jobs determined to be allowed based on the plugin parameters.

20. The non-transitory computer-readable medium of claim 15, wherein the one or more instructions, that cause the device to perform the one or more actions, cause the device to one or more of:
prevent the workflow from being implemented based on the final result;
cause the workflow to be implemented based on the final result;
provide the final result for display; or
retrain the machine learning model based on the final result.
